(19) United States
(12) Patent Application Publication
(10) Pub. No.: US 2016/0239723 A1
(43) Pub. Date: Aug. 18, 2016

(54) ENHANCED HOME SECURITY SYSTEM

(71) Applicant: Bess Technologies International Limited, CHENGDU (CN)

(72) Inventor: Liang Ge, Chengdu (CN)

(21) Appl. No.: 14/662,053

(22) Filed: Mar. 18, 2015

(30) Foreign Application Priority Data
Feb. 13, 2015 (CN) 201510076693.7

(51) Int. Cl. G06K 9/62; G06K 9/00; G06T 7/20; H04N 7/18

(52) U.S. Cl. CPC G06K 9/6253; H04N 7/181; G06K 9/00771; G06T 7/2006; G06T 2207/30232; G06T 2207/30241

(57) ABSTRACT

A solution is provided to enhance home security monitoring by pre-processing and post-processing home security surveillance data and by using a trained security model. A security controller receives motion data from motion sensors and digital cameras strategically installed in a home and pre-processes the motion data to detect possible candidates for the detected motion. The security controller is connected with a variety security sensors installed for monitoring home environment. Each of the security sensors sends an event signal to the security controller in response to a state change of the security sensor. The security controller analyzes the state changes and generates security alerts responsive to detection of security violation. A security server connected to the security controller post-analyzes the security surveillance video data to identify humans and animals responsible for the detected motion and trains a security model to guide the real time security monitoring by the security controller.

### CROSS REFERENCE TO RELATED APPLICATIONS

This application claims priority under 35 U.S.C. §119(a) from Chinese Patent Application No. 201510076693.7 filed on Feb. 13, 2015, which is hereby incorporated by reference for all purposes as if fully set forth herein.

### BACKGROUND

The disclosure relates generally to home security monitoring, and specifically to enhanced home security monitoring by pre-processing and post-processing of home security event signals.

The increasingly popular smart handheld devices, such as smart phones, tablet computers, residential electronics, such as photoelectronic smoke sensor, security cameras, and increased network bandwidth (for wired and wireless networks) have provided more communications platforms for home security and monitoring. A home security system generally allows a user to monitor a status of a home based on home security event signals sent by various security sensors or captured by indoor and/or outdoor security cameras installed in various locations of the home. For example, motion sensors installed in doorways, windows or other entry points to a home can be used to detect break-ins, and photoelectronic smoke sensor can alert the user of the presence of fire in the home.

Existing home security products can be categorized in three categories: traditional non-smart products, modern non-smart products and modern simple smart products. Traditional non-smart home security products often require multiple security devices, e.g., window sensor, doorway sensor, passive infra-red sensor (PIR), and alarm control, to be bundled together in order to provide a comprehensive view of home security. This solution is difficult to deploy because of the difficulty of installing the multiple security devices and high false alarm rates. Modern non-smart home security products often include video monitoring by capturing home security events by digital cameras. However, this solution may waste computing resources, such as network bandwidth and storage, because it analyzes the captured home security video without differentiating video content with motion from motionless video content. Modern simple smart home security products include many advanced home security electronics, such as dual sensor smoke detector with both ionization and photoelectronic smoke sensors, are designed to reduce false alarm rate by analysis of security event signals with cloud computing.

However, the existing solutions have a number of challenges, e.g., high false alarm rates, requirement of a large amount of network bandwidth and storage and single surveillance point. High false alarm rates disturb users by unreasonable large amount of false security events and degrade user experience. Existing solutions often waste system resources, such as network bandwidth and storage space, to store and transmit data of less value, such as 7×24 hours motionless video data from the camera deployed in various areas of a home. A comprehensive home security solution often requires comprehensive but efficient analysis of various home security event signals. Existing single surveillance point systems are challenged to meet such expectation.

### SUMMARY

Embodiments of the invention enhance home security monitoring by pre-processing and post-processing home security surveillance data and by using a trained security model. A security controller of an enhanced home security system receives motion data from motion sensors and from digital cameras strategically installed in a home and pre-processes the motion data to detect possible candidates for the detected motion. The security controller extracts all possible moving candidates from each video frame of the surveillance video and detects human faces and/or animals in the video frames. The security controller transmits the surveillance video content having the detected human faces and/or animals to a security server for further analysis.

The security controller is connected with a variety security sensors installed for monitoring home environment. Examples of security sensors include sensors for monitoring air quality, temperature, humidity, noise level, sudden move/earthquake and ambient light of the home. Each of the security sensors sends an event signal to the security controller in response to a state change of the security sensor. The security controller analyzes the state changes and generates security alerts responsive to detection of security violation.

The security server connected to the security controller post-analyzes the security surveillance video data to identify humans and animals responsible for the detected motion and trains a security model to guide the real time security monitoring by the security controller. The security controller uses the security model to detect unauthorized movement and issues security alerts in real time to authorized occupants of the home.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a block diagram of a computing environment for an enhanced home security system according to one embodiment.

FIG. 2 is a block diagram illustrating an example of a computing device for acting as a client, security controller and/or security server in one embodiment.

FIG. 3 is a block diagram illustrating computer modules of a detection module of the security controller in FIG. 1 according to one embodiment.

FIG. 4 is a block diagram illustrating computer modules of a pre-process module of the security controller in FIG. 1 according to one embodiment.

FIG. 5 is a block diagram illustrating computer modules of a post-process module of the security server in FIG. 1 according to one embodiment.

FIG. 6 is a block diagram illustrating computer modules of a modeling module of the security server in FIG. 1 according to one embodiment.

FIG. 7 is a flowchart illustrating exemplary operations of a security controller according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### System Overview

As used herein, a “dwelling,” “premises,” or “residential dwelling/premises” refers to an area monitored by the enhanced home security system. For purposes of simplicity and the description of one embodiment, the monitored area will be referred to as a “home,” but no limitation on the type of area that can be processed are indented by this terminology. Thus, the operations described herein for home security monitoring can be applied to any type of area, including business, industrial and other suitable types of area.

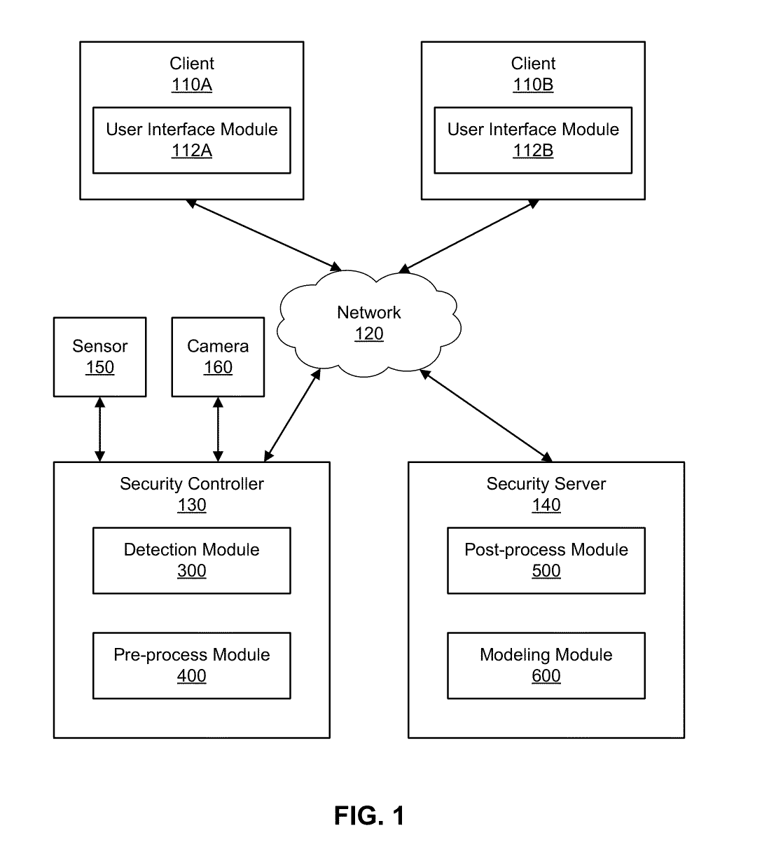

FIG. 1 is a block diagram of a computing environment 100 for an enhanced home security system according to one embodiment. The computing environment 100 includes a client 110A and a client 110B, a security controller 130, a security server 140, a sensor 150 and a camera 160 connected over a network 120. Only two client devices (110A and 110B), one security controller 130, one security server 140, one sensor 150 and one camera 160 are shown in FIG. 1 in order to simplify and clarify the description. Embodiments of the computing environment 100 can have many clients, security controllers 130, security servers 140, sensors 150 and cameras 160 connected to the network 120. Likewise, the functions performed by the various entities of FIG. 1 may differ in different embodiments.

A user of the client, e.g., 110A or 110B, receives home security alerts from the security controller 130 and instructs the security controller 130 to respond to security alerts and/or security event signals. In one embodiment, the client, e.g., 110A or 110B, is an electronic device used by a user to perform functions such as communicating home security instructions, executing software applications, browsing websites hosted by web servers on the network 120 and interacting with the security controller 130 and/or the security server 140. A client may be a smart phone, or a tablet, notebook, or desktop computer or a dedicated game console. The client includes and/or interfaces with a display device on which the user may view the text files, video files and other digital content.

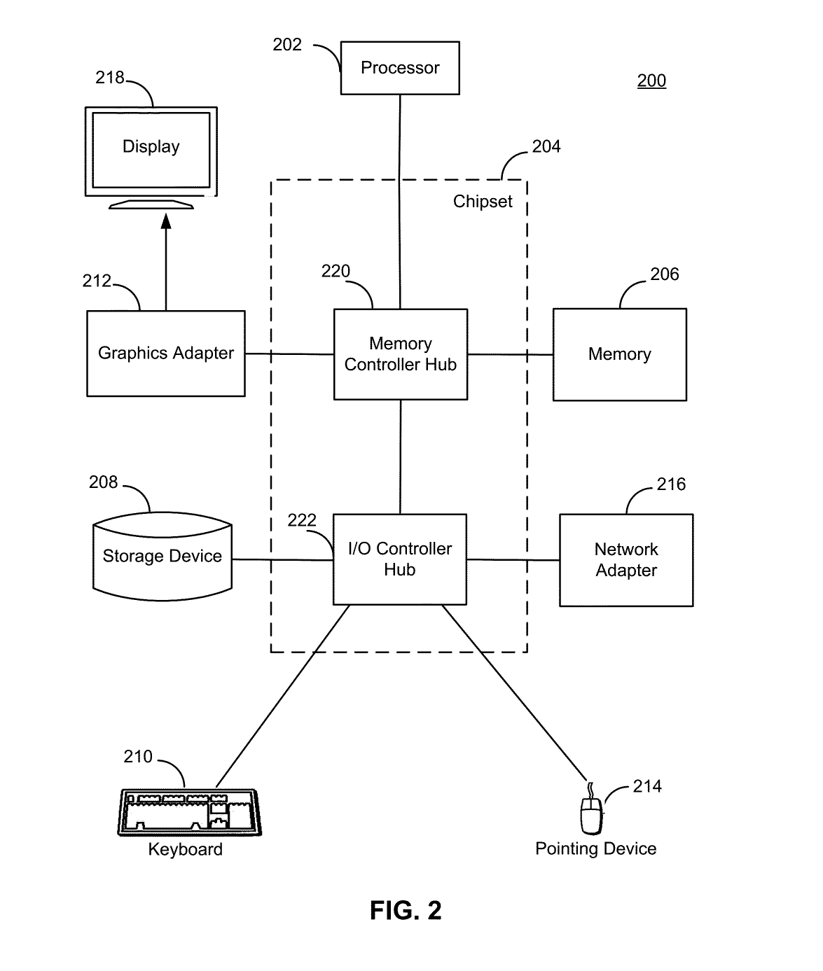

In one embodiment, the client provides a user interface (UI) module (e.g., 112A and 112B), such as physical and/or on-screen buttons, with which the user may interact with the client to perform functions such as receiving home security alerts, sending instructions to the security controller 130 on how to respond to the alerts, viewing and selecting digital content, downloading samples of digital content, purchasing digital content and sending electronic messages, such as electronic mails (emails) and text/video messages. An exemplary client is described in more detail below with reference to FIG. 2.

The security controller 130 is an electronic device that collects home security surveillance data from a variety of sensors, e.g., the sensor 150, and digital cameras, e.g., the camera 160, installed in various locations of a home and pre-processes the collected security surveillance data. In one embodiment, the security controller 130 has a detection module 300 and a pre-process module 400. Other embodiments of the security controller 130 may have additional and/or different modules than the ones described below.

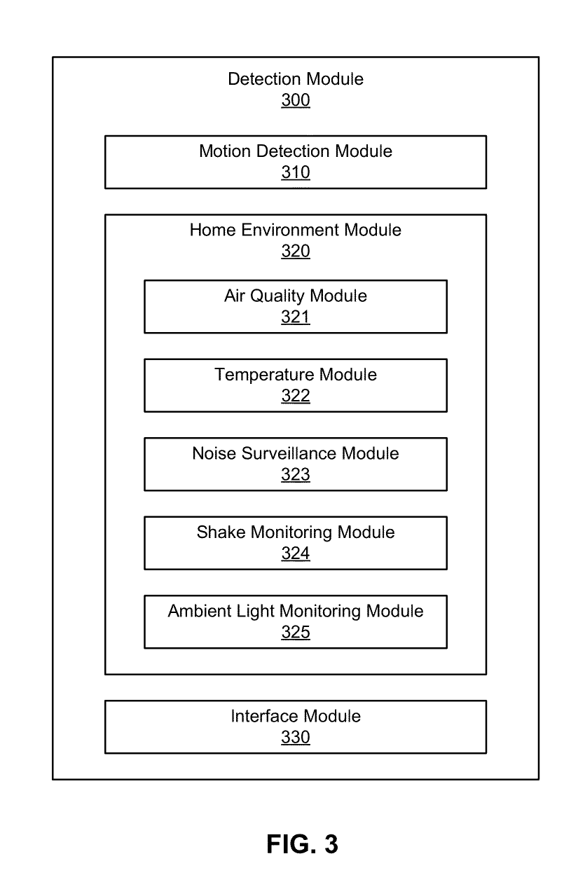

In one embodiment, the security controller 130 is connected with, wire or wireless, multiple sensors deployed throughout the home. Examples of sensors 150 installed in a dwelling, such as a residential home, include a motion sensor for detection unauthorized movement and one or more sensors for detecting various environment parameters associated with the dwelling, such as air quality, temperature, humidity, noise, earthquake and abnormal shake of the structure of the dwelling and lighting. Each of the sensors provides some security event signals to the security controller 130, which analyzes the event signals and generates security alerts responsive to detection of security breach through the detection module 300. The detection module 300 is further described below with reference to FIG. 3.

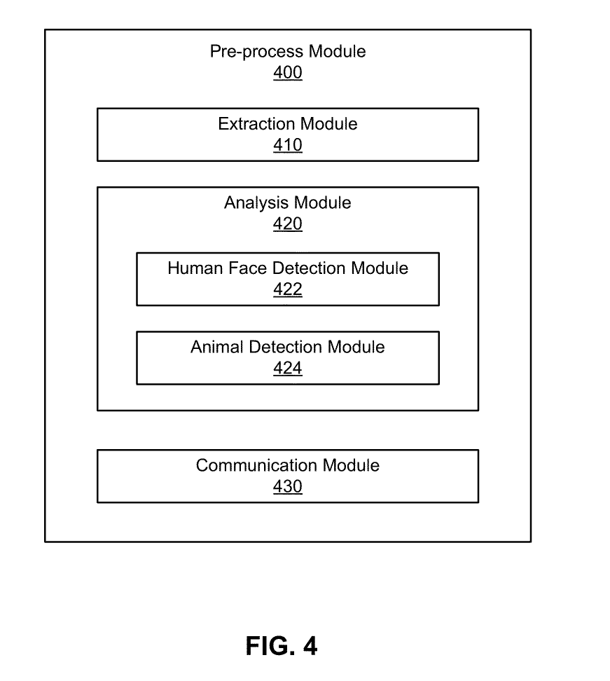

Furthermore, the pre-process module 400 of the security controller 130 analyzes the security video data to detect possible entities that contribute to the movement captured in the video by the cameras 160, such as humans or animals. Responsive to detecting humans and/or animals, the security controller 130 transmits the pre-processed video data to the security server 140 for further analysis. The pre-process module 400 is further described below with reference to FIG. 4.

The security server 140 is a computer server that facilitates home security data analysis and monitoring. In one embodiment, the security server 140 has a post-process module 500 and a modeling module 600. Other embodiments of the security server 140 may have additional and/or different modules than the ones described below.

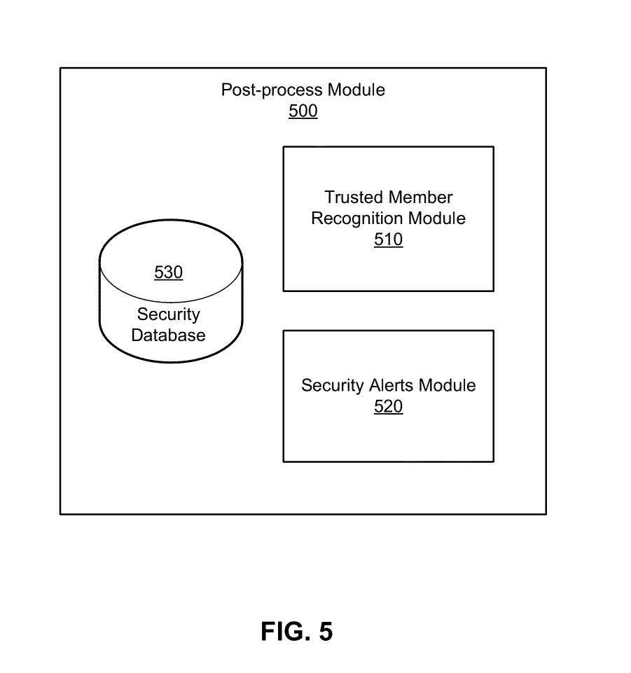

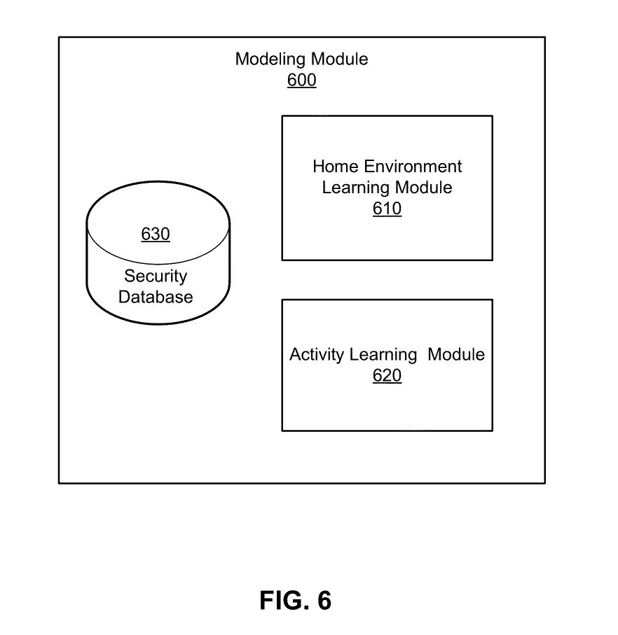

The post-process module 500 processes security data pre-processed by the security controller 130 and identifies the detected entities that caused the movement captured in the video data. The modeling module 600 of the security server 140 trains a security model offline based on security event training data in a security database and provides the trained security model to the security controller 130. The security controller 130 uses the trained security model to guide its real time event signals analysis. The post-process module 500 is further described below with reference to FIG. 5 and the modeling module 600 is further described below with reference to FIG. 6.

The network 120 enables communications among the client 110A, the client 110B, the security controller 130 and the security server 140 and can comprise the Internet as well as wireless communications networks. In one embodiment, the network 120 uses standard communications technologies and/or protocols. Thus, the network 120 can include links using technologies such as Ethernet, 802.11, worldwide interoperability for microwave access (WiMAX), 4G, digital subscriber line (DSL), asynchronous transfer mode (ATM), InfiniBand, PCI Express Advanced Switching, etc. Similarly, the networking protocols used on the network 120 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 120 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the network 120 is a cloud computing network and the entities of the network 120 can use custom and/or dedicated data communications technologies instead of, or in addition to, the ones described above.

### Computing System Architecture

The entities shown in FIG. 1 are implemented using one or more computers. FIG. 2 is a high-level block diagram of a computer 200 for acting as the client (110A and 110B), the security controller 130 and/or the security server 140. Illustrated are at least one processor 202 coupled to a chipset 204. Another embodiment of the computer 200 may include a video processor configured to receive and process video data captured by the camera 160 and/or video data from a motion sensor according to a video processing scheme. Also coupled to the chipset 204 are a memory 206, a storage device 208, a keyboard 210, a graphics adapter 212, a pointing device 214, and a network adapter 216. A display 218 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of the chipset 204.

The storage device 208 is any non-transitory computer-readable storage medium, such as a hard drive, compact disk read-only memory (CD-ROM), DVD, or a solid-state memory device. The memory 206 holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network 120.

As is known in the art, a computer 200 can have different and/or other components than those shown in FIG. 2. In one embodiment, the display 218 receives visual input generated by the processor 202. For example, the touch sensitive surface of the display 218 detects the touch operation on or near the touch sensitive surface and transmits the touch operation to the processor 202 to determine a type of the touch event. The processor 202 provides, according to the type of the touch event, a corresponding visual output to the display 218 for display.

The computer 200 functioning as the client 110A or the client 110B may have an audio circuit, a loudspeaker, and a microphone to provide audio interfaces between a user and the terminal. A WiFi module can be included in the client to provide wireless Internet access for the user, who can send or receive emails, browse webpages and access streaming media.

In addition, the computer 200 can lack certain illustrated components. For example, the computers acting as the security controller 130 or the security server 140 can be formed of multiple blade servers linked together into one or more distributed systems and lack components such as keyboards and displays. Moreover, the storage device 208 can be local and/or remote from the computer 200 (such as embodied within a storage area network (SAN)).

As is known in the art, the computer 200 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 208, loaded into the memory 206, and executed by the processor 202.

### Pre-Processing Home Security Event Signals

The security controller 130 collects home security surveillance data from a variety of sensors and digital cameras installed in various locations of a home and pre-processes the collected security surveillance data. In one embodiment, the security controller 130 has a detection module 300 to collect home security surveillance data from various sensors and digital cameras. FIG. 3 is a block diagram illustrating computer modules of the detection module 300 of the security controller 130 according to one embodiment. The embodiment illustrated in FIG. 3 has a motion detection module 310, a home environment module 320 and an interface module 330.

The motion detection module 310 collects motion data associated with a home from one or more motion sensors and digital cameras installed in various areas of the home. In one embodiment, the motion detection module 310 collects the motion data from motion sensors strategically installed in certain areas of the home, such as the doorways, windows and other points of entry to the home. A motion sensor can be radio frequency (RF) based and/or wireless and contain an optical, microware or acoustic sensor for detecting moving objects within a monitored area. Upon detecting a movement within the monitored area, a motion sensor sends an event signal to the motion detection module 310, where the event signal indicates a change of the state of the motion sensor. The motion detection module 310 determines whether the detected movement is authorized based on the change of the state of the motion sensor. For example, a motion sensor installed in the doorway detects the open and close of a door. If the opening and closing of the door lasts beyond a permitted entry/exit delay, the motion detection module 310 generates a security alert for a possible unauthorized entry/exit.

In another embodiment, the motion detection module 310 collects the motion data from digital cameras installed in certain areas of the home. A digital camera can be installed strategically in a home to track changes of doors, windows, and presence of a moving entity within the monitored area through the video frames/images captured by the digital camera. In one embodiment, the motion detection module 310 provides a home surveillance video to a pre-process module for analyzing the presence of moving entities, such as human bodies or animals, within the monitored area. FIG. 4 is a block diagram illustrating computer modules of a pre-process module 400 for detecting the presence of moving entities captured in a surveillance video of a home according to one embodiment.

In the embodiment illustrated in FIG. 4, the pre-process module 400 has an extraction module 410, an analysis module 420 and a communication module 430. The pre-process module 400 receives a home surveillance video from the motion detection module 310 and analyzes the video frames of the surveillance video for detecting human faces and animals captured in the surveillance video. The extraction module 410 extracts all possible moving candidates from each video frame of the surveillance video. In one embodiment, the extraction module 410 identifies a moving candidate in a video frame using any schemes known to those of ordinary skills in the art, such as object recognition based on object models which are known a priori and partial object recognition (also known as segmentation).

In another embodiment, the extraction module 410 analyzes a group of temporally sequential pictures of the home surveillance video and detects motion of an object across the group of pictures. For example, the extraction module 410 applies a motion estimation process to the group of pictures to derive motion vectors of pixels in a video frame. In another example, the extraction module 410 may apply an optical flow scheme to the group of pictures, where the motion vectors correspond to the perceived movement of pixels representing an entity of interest.

The analysis module 420 of the pre-process module 400 analyzes the moving candidates identified by the extraction module 410 to detect human faces and animals among the moving candidates. It is noted that the normal activities of humans, especially authorized occupants of a home, such as family members, and animals, such as family pets, are often the causes of false security alarms. By detecting human faces and animals, the analysis module 420 helps filter possible causes of false security alarms and reduce false alarm rates.

In one embodiment, the analysis module 420 has a human face detection module 422 and an animal detection module 424. The human face detection module 422 detects a human face among the moving candidates. In one embodiment, the human face detection module 422 compares a moving candidate with a set of predefined known human faces for children, adults, females and males. Based on the comparison, the human face detection module 422 determines whether the moving candidate is a human. The human face detection module 422 may assign a score for the determination, where the score indicates likelihood that the moving candidate is a human.

Similarly, the animal detection module 424 detects an animal among the moving candidates by comparing each moving candidate with a set of known animals, such as common family dogs and cats. Based on the comparison, the animal detection module 424 determines whether the moving candidate is an animal. The animal detection module 424 may assign a score for the determination, where the score indicates likelihood that the moving candidate is an animal.

The communication module 430 receives the analysis results from the human face detection module 422 and the animal detection module 424 and transmits the analysis results to the post-process module 500 of the security server 140 for further analysis. In one embodiment, the communication module 430 is also configured to receive a trained security model from the security server 140. The analysis module 420 of the pre-process module 400 can use the trained security model to guide its human face and animal detection. For example, the trained security model may provide a set of human faces of trusted family members and friends and family pets for the detection.

By filtering the surveillance video content captured by the digital camera, the pre-process module 400 reduces the amount of surveillance video content that needs to be transmitted to and analyzed by the security server 140. The pre-processing of the security surveillance video content by the pre-process module 400 improves the system performance by saving previous network bandwidth and storage space and reduces the false alarm rates.

Referring back to the detection module 300 in FIG. 3, the detection module 300 has a home environment module 320 to collect home security data from various security sensors, monitors and home appliances installed in a home. In one embodiment, the home environment module 320 has an air quality module 321, a temperature module 322, a noise surveillance module 323, a shake monitoring module 324 and an ambient light monitoring module 325. Other embodiments of the home environment module 320 may have different and/or additional modules, such as a humidity monitoring module and a water monitoring module.

The various modules of the home environment module 320 monitor the various environment parameters associated with a home. For example, the air quality module 321 tracks pollution level and detect leak of dangerous gas by monitoring the state change of one or more air quality sensors installed in a home. It is noted that some dangerous gas, such as carbon monoxide, is colorless and tasteless. By detecting the state change of a carbon monoxide sensor, the air quality module 321 can timely alert the occupants of the home, e.g., by sending an alert message to the smart phones of the occupants.

The temperature module 321 tracks the changes of temperature within a home, which can be vital to the security of human babies and family pets living in the monitored area. For example, the temperature change can be caused by the heat of a fire being developed in the monitored area. Responsive to the abnormal temperature change within the monitored area, the temperature module 321 can generate security alerts in real time.

The noise surveillance module 323 tracks sound pressure levels of one or more microphones installed in a home. For example, when an intruder breaks into a home, there may be some abnormal sound, such as door breaking sound, window cracking sound and pet barking sound, which is louder than the normally acceptable sound level. In response to the detection of abnormal sound, the noise surveillance module 323 can alert the occupants of the home.

Similarly, the shake monitoring module 324 tracks the sudden movement of the structure of a home by monitoring state changes of shake monitors, such as a three-dimensional (3D) accelerometer for detection earthquake. The ambient light monitoring module 325 detects abnormal sources of light within a monitored area, such as event signals from an infrared light sensor upon the heat generated by an intruder. Responsive to the detections of the state changes from the accelerometer and the light sensor, the shake monitoring module 324 and the ambient light monitoring module 325, respectively, generate security alerts.

The interface module 330 is configured to send security alerts to the clients, e.g., the smart phones, of related parties, such as the occupants of the home or legal authorities (e.g., police). In another embodiment, the interface module 330 also receives instructions of users of the clients about how to respond to the security alerts, such as to shut off electricity in response to detected abnormal temperature.

### Post-Processing Home Security Event Signals

In addition to pre-process security surveillance data by the security controller 130, the security server 140 provides comprehensive and in-depth analysis of the security surveillance data and trains a security model to guide the real time application of security monitoring by the security controller. In one embodiment, the security server 140 has a post-process module 500 for the further analysis of the security surveillance data and a modeling module 600 for training a security model offline. The security module 140 may perform the analysis and training using cloud computing techniques for fast system performance and high throughput. Other embodiments of the security server 140 may have different and/or additional modules. Likewise, the functions performed by the various entities of the security server 140 may differ in different embodiments.

FIG. 5 is a block diagram illustrating computer modules of a post-process module 500 of the security server 140 according to one embodiment. In the embodiment illustrated in FIG. 5, the post-process module 500 has a trusted member recognition module 510, a security alert module 520 and a security database 530. The post-process module 510 receives the security surveillance video content pre-processed by the pre-process module 400 of the security controller 130 and determines the identities of the moving candidates. In one embodiment, the trusted member recognition module 510 recognizes trusted members associated with the monitored area based on the data stored in the security database 530. The trusted members include the authorized human occupants of the monitored area, such as family members, and friends/relatives of the family members. The trusted member recognition module 510 compares a moving candidate of human faces with various images of the trusted members stored in the security database 530. Based on the comparison, the trusted member recognition module 510 determines whether a moving candidate is a trusted member.

The trusted members may also include authorized non-human occupants of the monitored area, such as family pets. The trusted member recognition module 510 compares a moving candidate of animals with various images of the trusted animal members stored in the security database 530. Based on the comparison, the trusted member recognition module 510 determines whether a moving candidate is a trusted animal member.

The security alerts module 520 is configured to generate security alerts based on the recognition results from the trusted member recognition module 510. Responsive to a moving candidate determined as a trusted member, human or animal, the security alerts module 520 does not issue any security alert; instead, the security alerts module 520 may send a message to the security controller 130 to indicate no violation of home security based on the security surveillance data. On the other hand, the security alerts module 520 issues a variety of security alerts in response to non-trusted members being detected in the surveillance video data. The type of the security alert may depend on the level of breach of the home security. For example, a non-trusted human breaking into a broken window will have a more serious alert than the one for a non-trusted stray cat crawling into the backyard.

The security database 530 stores various home security related data, such as user profile for each client and the monitored area associated with each client. The user profile may also include various images of family members associated with the monitored area, contact information and demographic information of the family members. The post-process module 500 periodically updates the security database or upon client request.

In addition to provide post-process analysis of home security surveillance video data, the security server 140 may also train a security model based on the learning of the environment of a monitored area and expected activities associated with the monitored area. It is noted that the environment parameters associated with a monitored area can be different during different times, such as during weekdays, weekends and holidays. For example, a monitored area is expected to be quieter during weekdays than during weekend, where more family members are expected to be home. Environment parameters associated with a monitored area can also be different during different time periods during a day. For example, a monitored area is expected to have more moving candidates during early morning and late afternoon. Furthermore, the environment parameters associated with a monitored area can be different during different seasons of a year. For example, the temperature of a home in winter time is expected to be higher than for the summer time due to the use of heaters and air conditioner. In one embodiment, the security server 140 has a modeling module 600 to learn the variations of the environment parameters and activities associated with the monitored area over time.

FIG. 6 is a block diagram illustrating computer modules of a modeling module 600 of the security server 140 according to one embodiment. The embodiment of the modeling module 600 in FIG. 6 has a home environment learning module 610, an activity learning module 620 and a security database 630. Other embodiments of the modeling module 600 may have different and/or additional modules than those described below.

The security database 630 stores statistics about the states of various security sensors installed in a home over a learning phase, which lasts a predefined period of time, e.g., a year. In one embodiment, the statistics about the states of various security sensors are collected by the security controller 130. The statistics from the learning phase can be further classified into classes for weekdays, weekends and holidays, or classes for different seasons. The statistics from the learning phase can be weighted, where different classes of the statistics can have different weights in real time application by the security controller 130. In one embodiment, the security database 630 of the modeling module 600 is a separate entity for the modeling module 600. In another embodiment, the modeling module 600 may share a security database with the post-process module 500 of the security server 140.

The home environment learning module 610 is configured to train a security model using the statistics learned during the learning phase. In one embodiment, the home environment learning module 610 trains the security model using one or more machine learning algorithms to analyze the learned statistics of various security sensors. Machine learning techniques and algorithms include, but are not limited to, neural networks, naïve Bayes, support vector machines and machine learning used in Hive frameworks. In one embodiment, the home environment learning module 610 trains the security model to analyze statistics related to air quality sensors, temperature sensors and humidity sensors installed in a monitored area.

The trained security model can be used to guide the real time security monitoring performed by the security controller 130. For example, the trained security model compares the state changes of a security sensor in real time monitoring with classified sensor state statistics of known security sensors of the same type in a similar time zone, e.g., a weekday. Based on the analysis, the security controller 130 determines whether the state change in real time monitoring is a real violation of home security.

The trained security model also enables the real time application with flexibility through its weighting scheme. For example, the temperature of a home may changes a lot between day and night in certain weather and season. The temperature change is also closed related to the location of the home. The trained security model allows the security controller 130 to count the influence of the local environment by considering local public temperature data together with real time temperature data from the temperature sensor installed in the home. The trained security model allows the security controller 130 to assign different weights to the local public temperature data and the real time temperature data.

The activity learning module 620 augments the training of the security model by the home environment learning module 610. It is noted that the noise level and ambient light of a monitored area are closely influenced by the level of activities observed in the monitored area. For example, the noise level is expected to be higher during a weekend when more family members are at home than a weekday when less family members are home. The activity learning module 620 learns the activities of the occupants of the monitored area during different times, e.g., weekends, weekdays and holidays, and classifies the learned data into different classes. The activity learning module 620 trains the security model based on the learned activities and the influence of the learned activities on the noise level and ambient light.

The augmented security model is used by the security controller 130 in real time monitoring to accurately analyze the state changes of noise surveillance sensors and ambient light surveillance sensors installed in the home. For example, the security controller 130 assigns different weights to the state changes observed during a weekday from those observed during a weekend.

### Exemplary Operations of a Security Controller

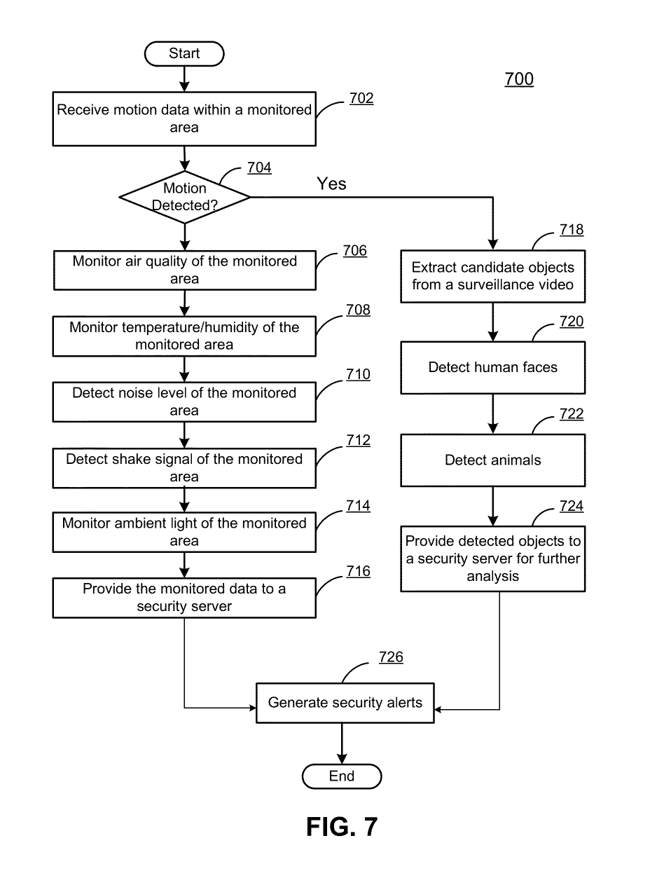

A solution is provided to enhance home security monitoring by pre-processing and post-processing home security surveillance data and by using a trained security model. FIG. 7 is a flowchart illustrating exemplary operations of a security controller 130 according to one embodiment. Initially, the security controller 130 receives 702 motion data from motion sensors and/or digital cameras strategically installed in various locations of a monitored area, e.g., the doorways and windows. The security controller 130 determines 704 whether any movement of one or more entities is detected in the motion data. Responsive to detected movement in a security surveillance video captured by the digital camera, the security controller 130 extracts 718 all possible moving candidates from each of the video frames of the surveillance video. The pre-process module 400 of the security controller 130 detects 720 one or more human faces and animals 722 among the moving candidates using object recognition or other suitable recognition techniques. In response to the detected objects being a human or an animal, the security controller 130 provides the selected surveillance video data to the security server 140 for further analysis.

The security controller 130 is also connected, wired or wireless, to a variety of security sensors that are installed to monitor the home environment of the monitored area. Each of the security sensors sends an event signal to the security controller 130 in response to a state change of the security sensor. In one embodiment, the security controller 130 monitors 706 the air quality of the monitored area through one or more air quality sensors. The security controller 130 also monitors 708 temperature or humidity of the monitored area through the temperature sensors and humidity monitors. The noise level of the monitored area is observed 710 by the security controller 130 through the monitoring of the sound pressure levels of one or more microphones installed in the monitored area. To detect 712 earthquake or sudden move of the building structure of the monitored area, the security controller 130 receives event signals from the accelerometers. The security controller 130 also monitors 714 the ambient light of the monitored home.

The security controller 130 provides 716 the monitored security data to the security server 140 for further analysis and/or training a security model. Responsive to a security violation observed by the security controller based on the pre-processing of the security data, the security controller 130 generates 726 security alerts in real time for the occupants of the monitored area. The security controller 130 also uses the security model trained by the security server 140 to guide its real time security monitoring.

### General

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A device for monitoring security of an area, comprising:
a computer processor for executing computer program modules; and
a non-transitory computer readable storage device storing computer program modules executable to perform steps comprising:
detecting motion within a monitored area, wherein the detecting comprises:
receiving a plurality of digital video frames of a video, the video capturing status of the monitored area for a predefined period of time;
extracting a plurality of candidates of digital video frames from the plurality of video frames, a candidate representing a video frame having a possible movement within the monitored area;
analyzing the extracted candidates; and
detecting movement of one or more objects within the monitored area based on the analysis;
monitoring a plurality of environment parameters associated with the monitored area; and
generating one or more security alerts based on detected motion and monitored environment parameters associated with the monitored area.

2. The device of claim 1, wherein the computer program module for detecting motion is further executed by the computer processor to perform steps of:
transmitting the detected movement of one or more objects to a computer server, the computer server adapted to determine whether the movement is from a trusted member associated with the monitored area;
receiving analysis result from the computer server; and
generating one or more security alerts based on the analysis result.

3. The device of claim 1, wherein the computer program module for detecting motion is further executed by the computer processor to perform steps of:
receiving analysis result from the computer server; and
generating one or more security alerts based on the analysis result.

4. The device of claim 1, wherein the computer module for monitoring a plurality of environment parameters associated with the monitored area is executed by the computer processor to perform steps of:
receiving event signals from a plurality of sensors within the monitored area, an event signal from a sensor providing information of at least one environment parameter associated with the monitored area.

5. The device of claim 1, wherein the plurality of environment parameters associated with the monitored area comprise at least one of the following:
parameters describing air quality of the monitored area;
parameters describing temperature of the monitored area;
parameters describing humidity of the monitored area;
parameters describing sudden movement of a building structure of the monitored area;
parameters describing noise level of the monitored area; and
parameters describing lighting of the monitored area.

6. The device of claim 1, further comprising a computer module executable to perform steps of:
receiving a trained security model from a computer server, the trained security model providing a set of trusted members associated with the monitored area and information about normal activities associated with the monitored area over different period of times; and
analyzing the detected motion and the plurality of environment parameters associated with the monitored area using the trained security model.

7. The device of claim 6, wherein the computer module for analyzing the detected motion and the plurality of environment parameters associated with the monitored area using the trained security model is further executed by the computer processor to perform steps of:
comparing a plurality of candidates generated from the detected motion with the set of trusted members associated with the monitored area;
responsive to a candidate not being a trusted member, generating a security alert;
comparing the environment parameters with information about normal activities associated with the monitored area; and
responsive to an environment parameter not associated with a normal activity, generating a security alert.

8. A method for monitoring security of an area, the method comprising:
detecting motion within a monitored area, wherein the detecting comprises:
receiving a plurality of digital video frames of a video, the video capturing status of the monitored area for a predefined period of time;
extracting a plurality of candidates of digital video frames from the plurality of video frames, a candidate representing a video frame having a possible movement within the monitored area;
analyzing the extracted candidates; and
detecting movement of one or more objects within the monitored area based on the analysis;
monitoring a plurality of environment parameters associated with the monitored area; and
generating one or more security alerts based on detected motion and monitored environment parameters associated with the monitored area.

9. The method of claim 8, wherein detecting motion further comprises:
transmitting the detected movement of one or more objects to a computer server, the computer server adapted to determine whether the movement is from a trusted member associated with the monitored area.

10. The method of claim 9, further comprising:
receiving analysis result from the computer server; and
generating one or more security alerts based on the analysis result.

11. The method of claim 8, wherein monitoring a plurality of environment parameters associated with the monitored area comprises receiving event signals from a plurality of sensors within the monitored area, an event signal from a sensor providing information of at least one environment parameter associated with the monitored area.

12. The method of claim 8, wherein the plurality of environment parameters associated with the monitored area comprise at least one of the following:
parameters describing air quality of the monitored area;
parameters describing temperature of the monitored area;
parameters describing humidity of the monitored area;
parameters describing sudden movement of a building structure of the monitored area;
parameters describing noise level of the monitored area; and
parameters describing lighting of the monitored area.

13. The method of claim 8, further comprising:
receiving a trained security model from a computer server, the trained security model providing a set of trusted members associated with the monitored area and information about normal activities associated with the monitored area over different period of times; and
analyzing the detected motion and the plurality of environment parameters associated with the monitored area using the trained security model.

14. The method of claim 13, wherein analyzing the detected motion and the plurality of environment parameters associated with the monitored area using the trained security model comprises:
comparing a plurality of candidates generated from the detected motion with the set of trusted members associated with the monitored area;
responsive to a candidate not being a trusted member, generating a security alert;
comparing the environment parameters with information about normal activities associated with the monitored area; and
responsive to an environment parameter not associated with a normal activity, generating a security alert.

15. A non-transitory computer readable storage medium storing executable computer program for monitoring security of an area, the computer program instructions comprising instructions that when executed by a computer processor perform steps of:
detecting motion within a monitored area, wherein the detecting comprises:
receiving a plurality of digital video frames of a video, the video capturing status of the monitored area for a predefined period of time;
extracting a plurality of candidates of video frames from the plurality of video frames, a candidate representing a video frame having a possible movement within the monitored area;
analyzing the extracted candidates; and
detecting movement of one or more objects within the monitored area based on the analysis;
monitoring a plurality of environment parameters associated with the monitored area; and
generating one or more security alerts based on detected motion and monitored environment parameters associated with the monitored area.

16. The computer readable storage medium of claim 15, wherein the computer program instructions for detecting motion further comprise instructions that when executed by the computer processor to perform steps of:
transmitting the detected movement of one or more objects to a computer server, the computer server adapted to determine whether the movement is from a trusted member associated with the monitored area.

17. The computer readable storage medium of claim 15, wherein the computer program instructions for detecting motion further comprise instructions that when executed by the computer processor to perform steps of:
receiving analysis result from the computer server; and
generating one or more security alerts based on the analysis result.

18. The computer readable storage medium of claim 15, wherein the computer program instructions for monitoring a plurality of environment parameters associated with the monitored area comprise instructions that when executed by the computer processor perform steps of receiving event signals from a plurality of sensors within the monitored area, an event signal from a sensor providing information of at least one environment parameter associated with the monitored area.

19. The computer readable storage medium of claim 15, wherein the plurality of environment parameters associated with the monitored area comprise at least one of the following:
parameters describing air quality of the monitored area;
parameters describing temperature of the monitored area;
parameters describing humidity of the monitored area;
parameters describing sudden movement of a building structure of the monitored area;
parameters describing noise level of the monitored area; and
parameters describing lighting of the monitored area.

20. The computer readable storage medium of claim 15, further comprising computer program instructions that when executed by the computer processor perform steps of:
receiving a trained security model from a computer server, the trained security model providing a set of trusted members associated with the monitored area and information about normal activities associated with the monitored area over different period of times; and
analyzing the detected motion and the plurality of environment parameters associated with the monitored area using the trained security model.
